(19) United States
(12) Patent Application Publication
(10) Pub. No.: US 2008/0079904 A1
(43) Pub. Date: Apr. 3, 2008

(54) Display systems with spatial light modulators

(75) Inventor: Terry Alan Bartlett, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/541,367

(22) Filed: Sep. 30, 2006

(51) Int. Cl. G03B 21/00

(52) U.S. Cl. 353/31

(57) ABSTRACT

A method and an optical system employing the same are provided for providing uniform illumination light with a desired illumination field using a surface diffuser.

### TECHNICAL FIELD OF THE INVENTION

The present invention relates to the art of illumination systems, and more particularly to the art of illumination systems for use in display systems that employ spatial light modulators.

### BACKGROUND OF THE INVENTION

During the past several years, solid state light sources, such as lasers and light-emitting-diodes (LEDs) have found recent application in display systems that employ spatial light modulators, such as liquid-crystal-displays and micromirror-based displays. This arises from the fact that solid state light sources when used in projection systems with spatial light modulators are superior over traditional arc lamps in many aspects, such as compact size, longer lifetime, and a narrower bandwidth.

Using solid state light source in display systems, however, is also challenging. One of the challenges is a uniform image shape that matches the shape of the spatial light modulator surface. A solid state light source, such as a laser, usually has a single emitter or an array of emitters typically spaced several hundreds microns in pitch, with an aperture of several to tens of microns in diameter. Depending on the type of laser, the emission characteristics can be much different. For example, a Vertical Cavity Surface Emitting Laser (VCSEL) typically emits into a narrow, symmetric beam; while an edge emitter laser emits into a larger asymmetric beam. The proposed solutions apply to a VCSEL emitter, and can also apply to an edge emitting laser array if anamorphic beam-shaping optics are used first to collimate the beams. In either instance, the light is desired to be effectively shaped to match the surface of the spatial light modulator using a robust, reliable, and cost-effective optical system.

Another challenge is to reduce unwanted artifacts, such as the visual laser coherent speckle in the image. Though conventional illumination systems such as optical integrators and fly's eyes can be used, they are often large and bulky and provide no method to reduce artifacts such as speckle. Specifically manufactured engineer diffusers may provide solutions, however, they usually require a large collimated beam in order to obtain a uniform illumination image at the spatial light modulator. Collimating the individual laser beams requires a custom collimating lens array that has to be precisely aligned with the laser beams—which is not convenient.

Therefore, an improved display system comprising a solid state light source and a spatial light modulator is desired.

### SUMMARY OF THE INVENTION

The objects and advantages of the present invention will be obvious, and in part appear hereafter and are accomplished by the present invention that:

As an object of the invention, a projection system is disclosed. The system comprises: a light source providing a light beam, a lens, an optical diffuser, and a spatial light modulator disposed along a propagation path of the light beam; and a moving mechanism coupled to an optical element within a propagation path of the light beam for moving said optical element so as to increase a uniformity of the illumination field of the light beam.

As another object of the invention, a method comprises: providing a light beam; directing the light beam from the light source to an optical diffuser; moving the optical diffuser in a direction perpendicular to a propagation path of the light beam so as to increase an illuminated area of the optical diffuser; and modulating the light beam output from the optical diffuser with a spatial light modulator.

As yet another object of the invention, a projection system comprises: a laser source providing a laser beam, a lens, an optical diffuser, and a spatial light modulator disposed along a propagation path of the light beam, wherein the optical diffuser comprises a surface that is composed of a plurality of scattering centers with random profiles.

As still yet another object of the invention, a method comprises: providing a laser beam with a laser source; directing the laser beam from the light source to an optical diffuser; transforming with the optical diffuser a first illumination field shape of the laser beam into a desired second illumination field shape, wherein the optical diffuser comprises a surface that is composed of a plurality of scattering centers of different profiles; and modulating the laser beam output from the optical diffuser with a spatial light modulator so as to form a desired image.

As yet another object of the invention, a projection system comprises: a light source providing a light beam; first and second optical diffusers and a lens disposed along a propagation path of the light beam so as to direct the light beam onto a spatial light modulator; and the spatial light modulator for modulating the light beam so as to form a desired image.

As yet another object of the invention, a method comprises: providing a light beam; adjusting a diameter of the light beam with a first optical diffuser; directing the light beam output from the first optical diffuser to a lens and a second optical diffuser so as to obtain a uniform light beam with a desired illumination field shape; directing the light beam from the second diffuser to a spatial light modulator for modulating the light beam.

As yet another object of the invention, a system comprises: a light source, a first lens, an optical diffuser, a light integrator, and a second lens disposed along a propagation path of a light beam from the light source such that: the light beam from the light source is converged onto the optical diffuser that is disposed at an entrance of the light integrator; and the light beam exiting from the light integrator is projected with the second lens to a spatial light modulator that modulates the light beam.

As yet another object of the invention, a method comprises: providing a light beam; converging the light beam onto an optical diffuser and an entrance of a light integrator, wherein the optical diffuser is at the entrance of the integrator; delivering the light beam to a lens with the light integrator; and illuminating a spatial light modulator with the light beam through the lens.

As yet another example of the invention, a system comprises: a light source providing a light beam; a lens assembly for reducing a diameter of the light beam, further comprising a concaved lens; an optical diffuser for transforming an illumination field profile of the light beam from the lens assembly into another illumination field profile; and a lens for projecting the light beam with the transformed illumination field onto a spatial light modulator.

As yet another object of the invention, a system comprises: a light source providing a light beam; a lens for converging the light beam onto a focal plane of the lens; an optical diffuser disposed at the focal plane of the lens; first and second fly's eyes integrators disposed such that the optical diffuser is at a focal plane of one of the first and second fly's eyes integrators for directing the light beam onto a spatial light modulator.

Such objects of the invention are achieved in the features of the independent claims attached hereto. Preferred embodiments are characterized in the dependent claims. In the claims, only elements denoted by the words “means for” are intended to be interpreted as means plus function claims under 35 U.S.C. §112, the sixth paragraph.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1 is an exemplary illumination system in accordance with an example of the invention;

FIG. 2 schematically illustrates a lateral extension profile of the far-field illumination light produced by the illumination system in FIG. 1;

FIG. 3 schematically illustrates a cross-sectional view of the optical diffuser in the illumination system shown in FIG. I in accordance with an example of the invention;

FIG. 4 is another exemplary illumination system in accordance with an example of the invention;

FIG. 5 is yet another exemplary illumination system in accordance with an example of the invention;

FIG. 6 is yet another exemplary illumination system in accordance with an example of the invention;

FIG. 7 is yet another exemplary illumination system in accordance with an example of the invention; and

FIG. 8 is still yet another exemplary illumination system in accordance with an example of the invention.

### DETAILED DESCRIPTION OF EXEMPLARY EMBODIMENTS

This invention discloses an illumination system used in projection systems that employ spatial light modulators. For providing uniform illumination light with a desired illumination field, the illumination system employs an optical diffuser.

In the following, the present invention will be discussed with reference to particular examples wherein the light source of the illumination system is laser. However, it will be appreciated that the following discussion is for demonstration purposes, and should not be interpreted as a limitation. Instead, other variations without departing from the spirit of the invention are also applicable. For example, the light source of the illumination system may also be another type of solid state light source, such as light-emitting-diodes, or even non-solid state light sources, such as arc lamps.

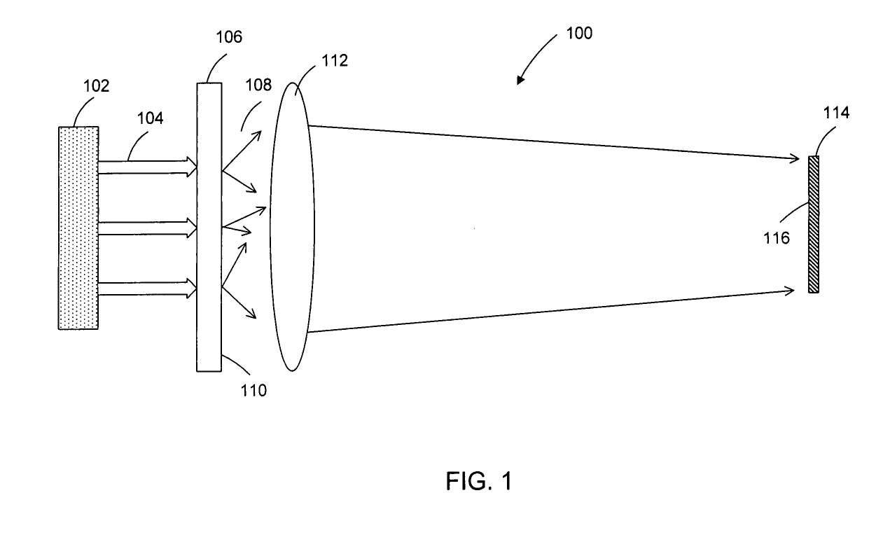

Referring to the drawings, FIG. 1 schematically illustrates an exemplary illumination system of the invention. Illumination system 100 comprises light source 102, optical diffuser 106, and converging lens 112 that are disposed along the propagation path of the light beam from the light source. In a display system, spatial light modulator 114 with reflective or transmissive area 116 can be disposed at a focal plane of converging lens 112.

The light source may use any desired solid state light sources, such as lasers and light-emitting-diodes (LEDs). The lasers can be ones that emit white light or any other suitable colors, such as red, green and blue. Exemplary laser sources are vertical cavity surface emitting lasers (VCSEL) and Novalux™ extended cavity surface emitting lasers (NECSEL), or any other suitable type of laser, e.g. lasers as set forth in each one of the following US patents and patent applications: 20060029120, 20050002433, U.S. Pat. Nos. 6,898,225, 6,778,582, 6,775,000, and 6,636,539, the subject matter of each being incorporated herein by reference in entirety. Depending upon specific applications, the light source may use a light source that provides a single light beam (e.g. a single laser beam) or may use an array of light sources to provide multiple light beams (e.g. multiple laser beams) for higher illumination intensity.

Optical diffuser 106 is provided herein for homogenizing the light beam incident thereto and transforming the incident light beam into light beams with pre-determined illumination field profiles. Specifically, the optical diffuser transforms the incident light beam (e.g. laser beam) into a light beam with uniform illumination intensity across the far-field illumination field. The far-field region is referred to as a region outside the near-field region, where the angular field distribution of the light is essentially independent of distance from the light source. As a way of example, if the light source has a maximum overall dimension D that is large compared to the wavelength, the far-field region is commonly taken to exist at distances greater than 2D²/λ from the source, k being the wavelength. For a beam focused at infinity, the far-field region is sometimes referred to as the Fraunhofer region. Other synonyms and mutually exchangeable terminologies are far field, far zone, and radiation field.

The above energy distribution transformation can also be accompanied by angular distribution (i.e. spatial) transformation. The optical diffuser can transform the illumination field of the incident light beam into a pre-determined far-field illumination field profile, such as circles, ellipses, rectangles, and any other desired shapes. In general, it is desired that the far-field illumination field has a shape that matches the target illumination area, such as the rectangular transmissive or reflective areas of spatial light modulators. It is further preferred that the rectangular illumination field (if rectangular is desired) has an area that is substantially the same as the reflective or transmissive area of the spatial light modulator.

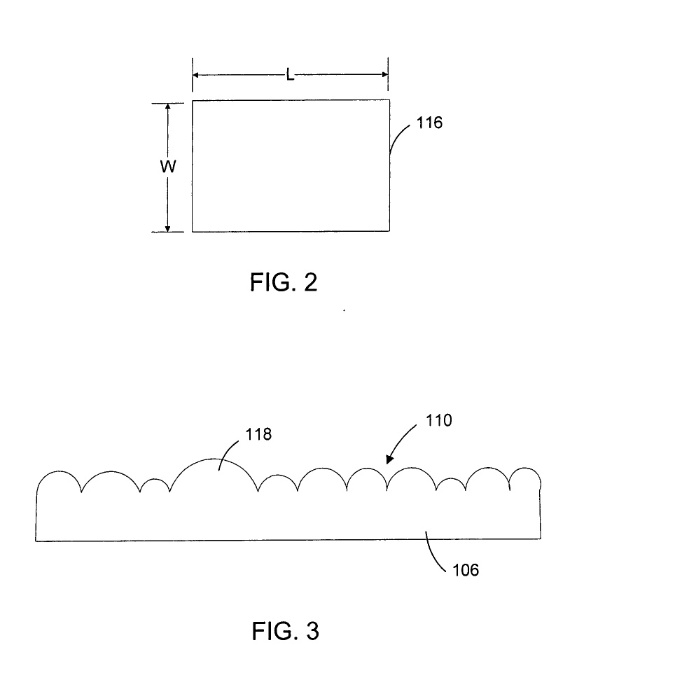

As an example, FIG. 2 illustrates a top view of rectangular area 116 of spatial light modulator 114 illustrated in FIG. 1. The area has a length L and width W. The ratio of L/W is referred to as the aspect ratio; and the diagonal of the rectangular area is defined as the square root of (L²+W²). The aspect ratio of the area can be 4:3, 16:9, 16:10, or any desired aspect ratio. The diagonal can be 0.7 inch or less, such as 0.5 inch or less, or even 0.3 inch or less.

The homogenization capability of the optical diffuser is related to the random distribution of its scattering centers, which constitute the features responsible for directing the incident light into various directions within the spread of the optical diffuser. Depending upon different locations of the scattering centers, the optical diffuser can be a volume optical diffuser where the scattering centers are within the bulk body of the diffuser, or a surface diffuser where the scattering centers are on the surface of the bulk body of the diffuser. In an example of the invention, the optical diffuser is a surface diffuser, such as an engineered diffuser. FIG. 3 demonstratively illustrates a cross sectional view of the engineered diffuser used in the illumination system shown in FIG. 1.

Referring to FIG. 3, optical diffuser 106 comprises surface 110 with varying surface profiles. Surface 110 is composed of a plurality of scattering centers, such as scattering center 118. For obtaining uniform intensity, the scattering centers are made of random dimensions. For obtaining a rectangular illumination field, the scattering centers can form a substantially rectangular array.

Referring back to FIG. 1, the laser light source, optical diffuser that can be an engineered diffuser, and converging lens 112 can be disposed along the propagation of the light beam from the light source. In operation, laser beam 104 from light source 102 passes through optical diffuser 106 and becomes spread and homogenized light beam 108 with desired illumination field. The illumination field is preferred to match the reflective or transmissive surface 116 of spatial light modulator 114. Transformed light 108 is collected and projected by converging lens 112 onto the reflective or transmissive surface 116 of spatial light modulator that is disposed at a focal plane of converging lens 112. The pixels of the spatial light modulator, which can be reflective and deflectable micromirrors, transmissive LCD cells, or reflective LCD cells (e.g. liquid-crystal-on-silicon, LCOS cells), individually modulate the incident light beam according to image data (e.g. bit plane data) derived from the desired image. The modulated light beam is then projected by a projection lens (not shown) onto a display target (not shown) for viewing.

A potential problem with the illumination system as shown in FIG. 1 may be that a small area of the engineered diffuser is illuminated which means that only a few lenset facets are illuminated, which may results in non-uniformity in the far-field illumination field. This arises from the fact that a single laser beam has a diameter of approximately 0.1 mm, whereas a laser beam with the diameter of a few millimeters is desired to illuminate a large enough number of lensets to obtain a uniform far-field illuminate field. This difficulty can be solved by moving the diffuser relative to the laser beam. For example, the diffuser can be moved in a direction perpendicular to the optical axis or the propagation path of the laser beam. It is preferred that the diffuser movement is movement above a threshold frequency, preferably at least faster than the integration time of the human eye, such that the human eye is not able to detect the movement, and the illumination field appears to be uniform. This technique of moving the diffuser has other benefits. For example, moving the diffuser can also reduce the perceived speckle level by rapidly (e.g. above the threshold frequency) presenting different speckle patterns in time.

The optical diffuser can be moved in many ways. For example, the diffuser can be attached to a vibrator (e.g. a microactuator—such as a piezoelectric actuator) that vibrates the diffuser. Alternatively, the optical diffuser can be mounted on a wheel that spins the diffuser. Of course, a variety of other means can be used to move the diffuser, which will not be discussed herein. In another example, a lens or mirror disposed along the light path between the diffuser and the target could be moved instead of moving the diffuser itself.

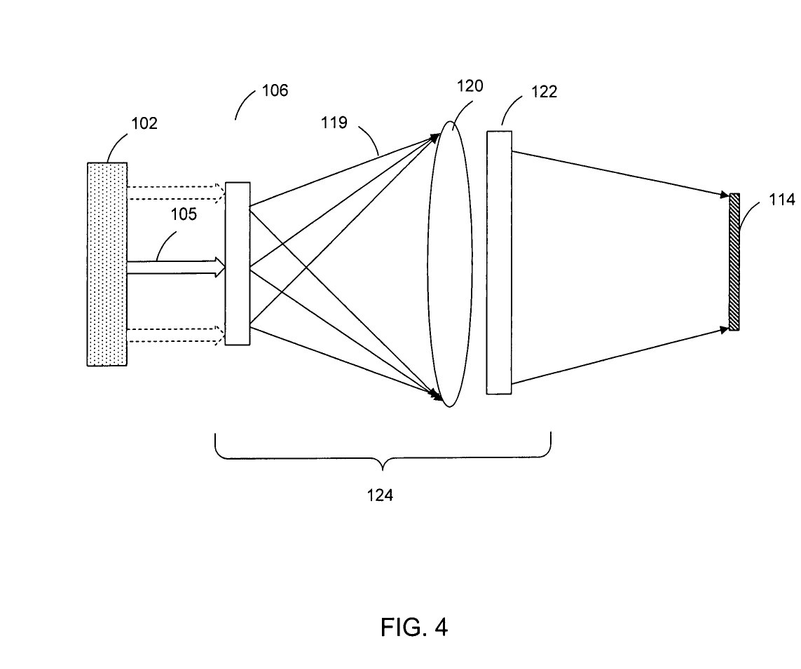

Another exemplary illumination system of the invention is illustrated in FIG. 4. Referring to FIG. 4, illumination system comprises light source 102 and image relay assembly 124 that further comprises optical diffusers 106 and 122 and relay lens 120 that is disposed between the two optical diffusers. Light source 102 in this particular example may provide one single light beam, such as a single laser beam. Optical diffuser 106 is preferably an engineered diffuser whose characteristic scattering profile is substantially flat within an angular range of from 1° to 50°, and more preferably from 5°-20°. Either one or both of the optical diffusers 106 and 122 can be the same or different from optical diffuser 106 in FIG. 1, and need not be the same as each other (though they may be); and can be moved in the same or different ways as the optical diffuser 106 as discussed with reference to FIG. 1. And, as with FIG. 1, an additional optical element (e.g. lens or mirror) could be provided along the propagation path of the light beam between the diffuser and the target on which an image is formed.

In this particular example, image relay assembly 124 projects the laser light beam onto a focal plane on which spatial light modulator 114 is disposed such that the laser light at the focal plate (on the spatial light modulator) is substantially uniform and has the desired illumination shape, such as rectangular. At the reflective or transmissive surface of the spatial light modulator, the illumination field of the laser beam is substantially rectangular and uniform.

In operation, the first optical diffuser 106 expands laser beam 105, which can be a single laser beam from a laser emitter, so that a larger area is illuminated on the second optical diffuser 122. The second optical diffuser 122 creates a rectangular far-field illumination field which can be imaged onto the reflective and transmissive surface of spatial light modulator 114 using relay lens 120. Although the expanded illumination field at the input to the second optical diffuser may not be perfectly uniform, it illuminates enough lenset facets of the second optical diffuser to produce a uniform illumination field at the surface of the spatial light modulator. In this example, either one or both of the optical diffusers 106 and 122 can be moved in the same or different ways as the optical diffuser 106 in FIG. 1. And, as with FIG. 1, an additional optical element (e.g. lens or mirror) could be provided along the propagation path of the light beam between the diffuser and the target on which an image is formed.

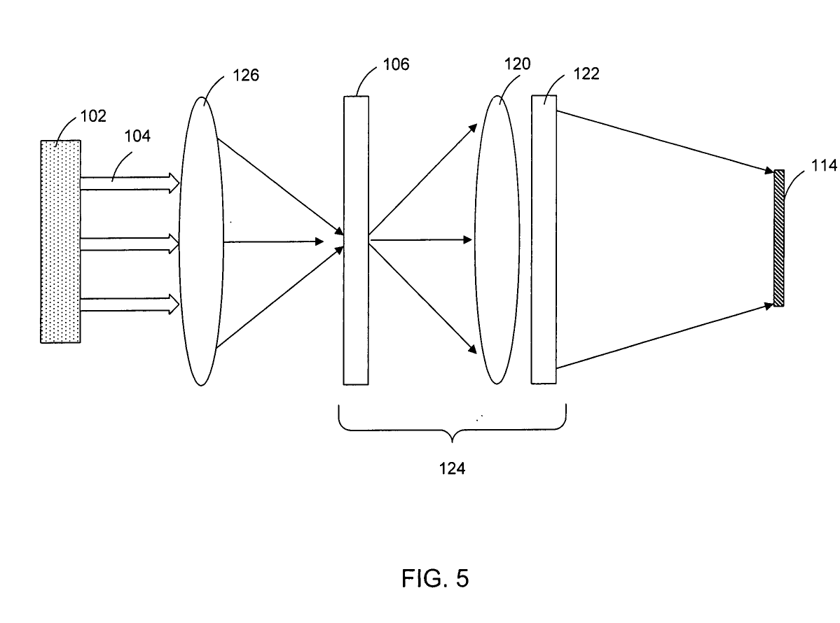

A variation of the illumination in FIG. 4 is schematically illustrated in FIG. 5. Referring to FIG. 5, converging lens 126 is disposed between the first optical diffuser 106 and light source 102. When multiple laser beams are emitted from the light source, converging lens 126 converges the laser beams onto a focal plane wherein the first optical diffuser 106 is disposed. Optical diffuser 106 is preferably an engineered diffuser whose characteristic scattering profile is substantially flat within an angular range from 1° to 50°, and more preferably from 5°-20°. The first optical diffuser expands the converged laser beams such that more lenset facets at the second optical diffuser 122 can be illuminated. The second optical diffuser 122, which can be an engineered rectangular far-field diffuser, creates a rectangular far-field illumination field which can be imaged onto the reflective and transmissive surface of spatial light modulator 114 using relay lens 120. Either one or both of the optical diffusers can be moved in the same or different ways as the optical diffuser 106 as discussed above with reference to FIG. 1. And, as with FIG. 1, an additional optical element (e.g. lens or mirror) could be provided along the propagation path of the light beam between the diffuser and the target on which an image is formed.

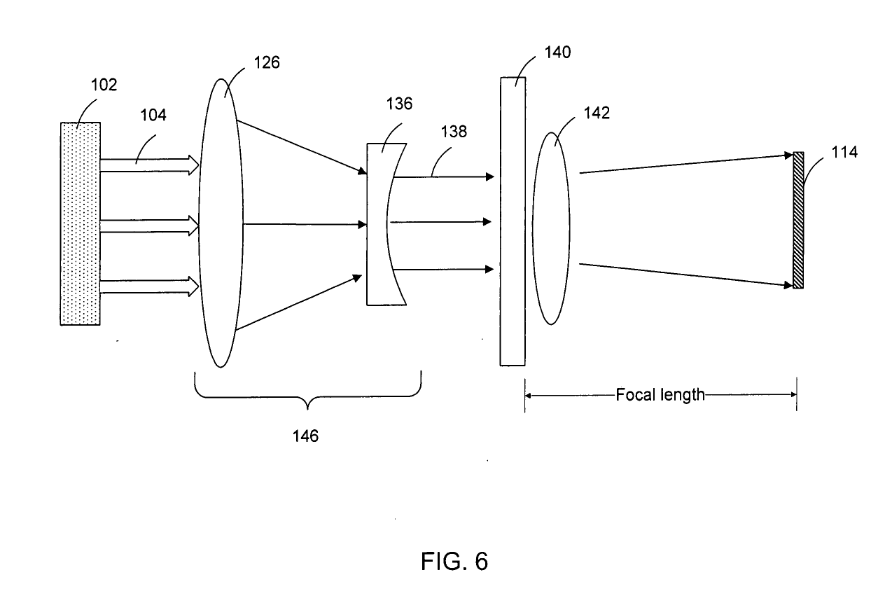

Another exemplary illumination system of the invention is schematically illustrated in FIG. 6. Referring to FIG. 6, the illumination system comprises light source 102, beam reducing assembly 146 that further comprises converging lens 126 and lens 136 that is disposed at a focal plane of lens 126, optical diffuser 140 that can be an engineered rectangular far-field diffuser, and converging lens 142.

When multiple laser beams 104 from light source 102 are captured by beam reducing assembly 146, converging lens 126 converges the incident light beams onto a focal plane wherein lens 136 is disposed. The laser beams output from lens 136 is parallel. The parallel laser beam then passes through optical diffuser 140 that homogenizes and spreads the incident light beams. The homogenized and spread laser beams are projected by lens 142 onto a focal plane in which spatial light modulator 114 is disposed. The shape of the illumination field at the surface of the spatial light modulator can be adjusted by optical diffuser 140 as discussed above with reference to FIG. 1. The optical diffuser can be moved in the same or different ways as the optical diffuser 106 as discussed above with reference to FIG. 1, which will not be repeated herein. And, as with FIG. 1, an additional optical element (e.g. lens or mirror) could be provided along the propagation path of the light beam between the diffuser and the target on which an image is formed.

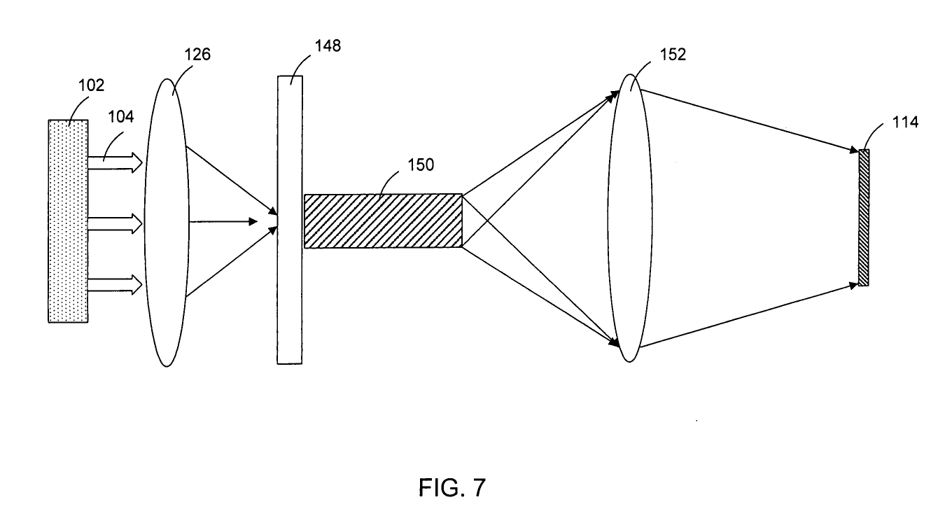

Another exemplary illumination system of the invention is schematically illustrated in FIG. 7. Referring to FIG. 7, the illumination system comprises light source 102, converging lens 126, optical diffuser 148 that is disposed at a focal plane of converging lens 126, light integrator 150, and lens 152 that is disposed such that the exit of the light integrator 150 is-at a focal plane of projection lens 152. Optical diffuser 148 is preferably an engineered diffuser whose characteristic scattering profile is substantially flat within an angular range from 1° to 50°, and more preferably from 5°-20°. It is also possible to have an additional diffuser placed at the output face of integrator rod 150 (or at a position somewhere between the integrator rod and the spatial light modulator along the propagation path of the light beam), with or without optical diffuser 148 being present.

The example shown in the figure can use any suitable light integrator, such as a rectangular solid light transmissive integrator (e.g. a piece of light transmissive polymer or glass with rectangular cross section) or a hollow, mirrored light integrator to achieve illumination field uniformity. Optical diffuser 148 is employed at the input of the light integrator so as to make the angular distribution of the laser beams uniform which improves the laser beam mixing in the light integrator. It is noted that the optical diffuser in this example can be moved in the same or different ways as the optical diffuser 106 as discussed above with reference to FIG. 1. And, as with FIG. 1, an additional optical element (e.g. lens or mirror) could be provided along the propagation path of the light beam between the diffuser and the target on which an image is formed.

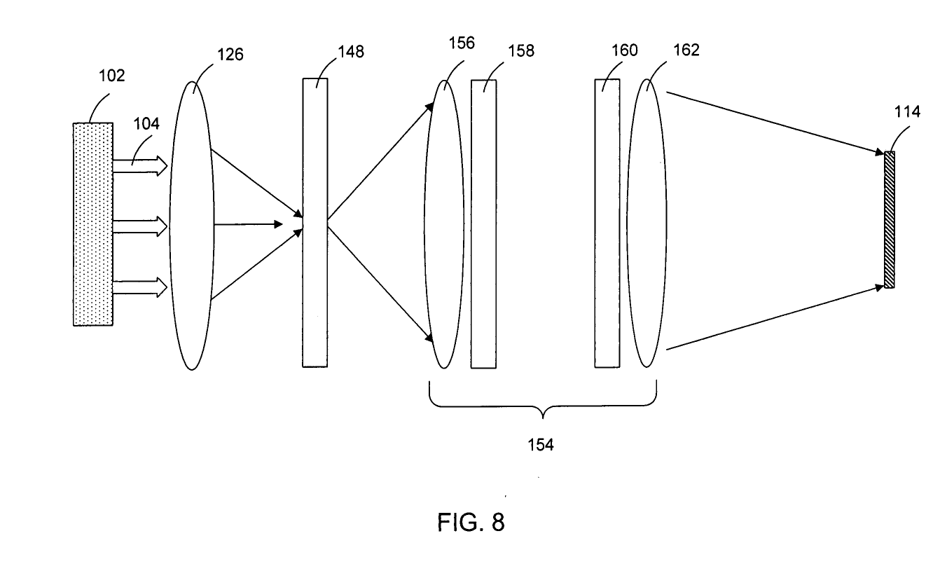

FIG. 8 schematically illustrates another exemplary illumination system of the invention. Referring to FIG. 8, the illumination system comprises light source 102, lens 126, optical diffuser 148, and fly's eyes assembly 154. The fly's eyes assembly in this example further comprises fly's eyes lenses 156 and 162 and optical diffusers 158 and 160 disposed between the fly's eyes lenses. Optical diffuser 148 is preferably an engineered diffuser whose characteristic scattering profile is substantially flat within an angular range from 1° to 50°, and more preferably from 5°-20°.

The example as shown in the figure employs a combination of lens 126 and optical diffuser that is disposed at a focal plane of lens 126 so as to collimate the laser beams from the light source. Meanwhile, the laser beams can be homogenized and reshape the illumination field. The fly's eyes assembly 154 integrated the output laser beams from optical diffuser 148 so as to achieve uniform illumination field with rectangular field shape at the reflective or transmissive surface of spatial light modulator 114 that is disposed at a focal plane of the fly's eyes assembly 154. As an alternative feature, the optical diffuser 148 can be moved in the same or different ways as the optical diffuser 106 discussed above with reference to FIG. 1. And, as with FIG. I an additional optical element (e.g. lens or mirror) could be provided along the propagation path of the light beam between the diffuser and the target on which an image is formed.

The illumination systems of the invention can be used in display systems that employ spatial light modulators. The pixels of spatial light modulators can be any suitable plurality of pixels—such as micromirrors, transmissive liquid crystals, reflective liquid crystals (e.g. liquid-crystal-on-silicon LCOS), or other types of cells.

When the micromirrors are used for the pixels of the spatial light modulators, the micromirrors each can comprise a reflective and deflectable mirror plate attached to a deformable hinge. An addressing electrode connected to an electric circuit can be placed proximate to the mirror plate for electrostatically deflecting the mirror plate. Other deflection mechanisms (non-electrostatic) could be used if desired.

The mirror plate may or may not be formed on the same substrate on which the addressing electrodes are formed; and the mirror plate and deformable hinge may or may not be formed on the same plane at the natural resting state. The mirror plate can be formed by a thin film deposition method, such as PECVD, PVD, CVD, and sputtering, or alternatively, be derived from single a crystal, which not be discussed in detail herein.

When used in display systems, a color wheel may be incorporated into the illumination system of the invention, though not required, if the light source is a white light or secondary color light source. The color wheel comprises a set of color segments, such as red, green, and blue, or cyan, magenta, and yellow, or white, or any combinations thereof—though color wheels generally would not be needed with solid state illumination. Depending upon the system arrangement, the projection system can be a front projector, or a rear projector (e.g. a rear projection television).

It will be appreciated by those of skill in the art that a new and useful illumination system for use in display systems that employ spatial light modulators has been described herein. In view of the many possible embodiments to which the principles of this invention may be applied, however, it should be recognized that the embodiments described herein with respect to the drawing figures are meant to be illustrative only and should not be taken as limiting the scope of invention. Those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

I claim:

1. A projection system, comprising:
a light source providing a light beam, a lens, a surface diffuser, and a spatial light modulator disposed along a propagation path of the light beam; and
a moving mechanism coupled to an optical element within a propagation path of the light beam for moving said optical element so as to increase a uniformity of the illumination field of the light beam incident on the spatial light modulator.

2. The system of claim 1, wherein the moving mechanism is coupled to the engineered diffuser for moving said engineered diffuser.

3. The system of claim 2, wherein the light beam is a laser.

4. The system of claim 3, wherein the laser is a vertical cavity, surface emitting laser.

5. The system of claim 3, wherein the laser is a NECSEL.

6. The system of claim 2, wherein the light source, engineered diffuser, and lens are arranged such that a far-field illumination field of the light beam is substantially rectangular.

7. The system of claim 6, wherein an energy distribution of the light beam across the rectangular far-field illumination field is substantially uniform.

8. The system of claim 6, wherein the rectangular field has an aspect ratio of substantially 16:9, 16:10, or 4:3.

9. The system of claim 6, wherein the rectangular field has a diagonal of around 0.7 or less.

10. The system of claim 9, wherein the diagonal is around 0.5 or less.

11. The system of claim 1, further comprising:
a beam reducing assembly that further comprises: a converging lens and a beam expander that is disposed as a focal plane of the converging lens such that the light beam output from the beam expander is substantially parallel and has a diameter that is less than that of the incident light beam; and
wherein said beam reducing assembly is disposed between the light source and the optical diffuser along the propagation path of the light beam.

12. The system of claim 1, wherein the spatial light modulator comprises an array of reflective and deflectable micromirrors.

13. The system of claim 1, wherein the spatial light modulator comprises an array of liquid crystal cells.

14. The system of claim 13, wherein the liquid crystal cells are transmissive liquid crystal cells.

15. The system of claim 13, wherein the liquid crystal cells are liquid crystal on silicon cells.

16. The system of claim 1, further comprising;
a beam expander for expanding the light beam.

17. The system of claim 1, further comprising:
a fly's eyes lens.

18. A method, comprising:
providing a light beam;
directing the light beam from the light source to an engineered diffuser;
moving the optical diffuser relative to a propagation path of the light beam so as to increase a uniformity of an illuminated area of a spatial light modulator; and
modulating the light beam output from the optical diffuser with a spatial light modulator.

19. The method of claim 18, wherein the light beam from the light source has a first illumination field shape that is different from a second illumination field shape of the light beam output from the optical diffuser.

20. The method of claim 19, wherein the second illumination field shape is substantially rectangular.

21. The method of claim 19, wherein the intensity distribution of the light beam is substantially uniform across the rectangular illumination field.

22. The method of claim 18, wherein the step of moving the optical diffuser further comprises:
vibrating the optical diffuser in a direction perpendicular to the propagation path of the light beam.

23. The method of claim 18, wherein the step of moving the engineered diffuser further comprises:
spinning the optical diffuser.

24. The method of claim 18, wherein the engineered diffuser comprises a surface that is composed of a plurality of scattering centers with non-uniform profiles.

25. The method of claim 18, further comprising:
reducing a diameter of the laser beam by a beam reducing assembly.

26. The method of claim 24, further comprising:
directing the light beam output from the engineered diffuser onto a spatial light modulator.

27. The method of claim 26, wherein the spatial light modulator comprises an array of reflective and deflectable micromirrors.

28. The method of claim 27, wherein the micromirror array has an aspect ratio of 16:9, 16:10, or 4:3.

29. The method of claim 28, wherein the micromirror array has a diagonal of 0.7 inch or less.

30. The method of claim 27, wherein the micromirror array has a diagonal of 0.5 inch or less.

31. The method of claim 27, wherein the micromirror array has a diagonal of 0.3 inch or less.

32. A projection system, comprising:
a laser source providing a laser beam, a lens, an engineered diffuser, and a spatial light modulator disposed along a propagation path of the light beam, wherein the optical diffuser comprises a surface that is composed of a plurality of scattering centers with random profiles.

33. The system of claim 32, further comprising:
a moving mechanism coupled to an optical element within a propagation path of the light beam for moving said optical element so as to increase a uniformity of the illumination field of the light beam.

34. The system of claim 33, wherein the moving mechanism is coupled to the engineered diffuser for moving said engineered diffuser.

35. The system of claim 32, wherein the laser is a vertical cavity surface emitting laser.

36. The system of claim 32, wherein the laser is a NECSEL.

37. The system of claim 32, wherein the light source, engineered diffuser, and lens are arranged such that a far-field illumination field of the light beam is substantially rectangular.

38. The system of claim 37, wherein an energy distribution of the light beam across the rectangular far-field illumination field is substantially uniform.

39. The system of claim 37, wherein the rectangular has an aspect ratio of substantially 16:9, 16:10, or 4:3.

40. The system of claim 37, wherein the rectangular has a diagonal of substantially 0.7 or less.

41. The system of claim 40, wherein the diagonal is substantially 0.5 or less.

42. The system of claim 32, further comprising:
a beam reducing assembly that further comprises: a converging lens and a beam expander that is disposed as a focal plane of the converging lens such that the light beam output from the beam expander is substantially parallel and has a diameter that is less than that of the incident light beam; and
wherein said beam reducing assembly is disposed between the light source and the optical diffuser along the propagation path of the light beam.

43. The system of claim 32, wherein the spatial light modulator comprises an array of reflective and deflectable micromirrors for modulating the laser beam.

44. A method, comprising:
providing a laser beam with a laser source;
directing the laser beam from the light source to an optical diffuser;
transforming with the optical diffuser a first illumination field shape of the laser beam into a rectangular illumination field shape at far field, wherein the optical diffuser comprises a surface that is composed of a plurality of scattering centers of different profiles; and
modulating the laser beam output from the optical diffuser with a spatial light modulator so as to form a desired image.

45. The method of claim 44, further comprising:
moving the optical diffuser in a direction relative to a propagation path of the laser beam so as to increase a uniformity of an area of the spatial light modulator being illuminated by the laser beam.

46. The method of claim 45, wherein the second illumination field shape is substantially rectangular.

47. The method of claim 45, wherein the intensity distribution of the laser beam is substantially uniform across the rectangular illumination field.

48. The method of claim 45, wherein the step of moving the optical diffuser further comprises:
vibrating the optical diffuser in a direction perpendicular to the propagation path of the laser beam.

49. The method of claim 45, wherein the step of moving the optical diffuser further comprises:
spinning the optical diffuser.

50. The method of claim 45, further comprising:
reducing a diameter of the laser beam by a beam reducing assembly.

51. The method of claim 47, wherein the spatial light modulator comprises an array of reflective and deflectable micromirrors.

52. The method of claim 50, wherein the rectangular illumination field has an aspect ratio of around 16:9, 16:10, or 4:3.

53. The method of claim 50, wherein the rectangular illumination filed has a diagonal of around 0.7 inch or less.

54. The method of claim 50, wherein the rectangular illumination filed has a diagonal of around 0.5 inch or less.

55. The method of claim 50, wherein the rectangular illumination filed has a diagonal of around 0.3 inch or less.

56. A method, comprising:
providing a laser beam with a laser source;
directing the laser beam from the light source to a spatial light modulator through an optical diffuser;
transforming with the optical diffuser a first illumination field shape of the laser beam into a second illumination field shape at far field, wherein an amount of light that is incident on the spatial light modulator compared to an amount of light that is incident on the diffuser is at least 80%; and
modulating the laser beam output from the optical diffuser with a spatial light modulator so as to form a desired image.

57. The method of claim 56, further comprising:
moving the optical diffuser in a direction relative to a propagation path of the laser beam so as to increase an area of the optical diffuser being illuminated by the laser beam.

58. The method of claim 56, wherein the second illumination field shape is substantially rectangular.

59. The method of claim 56, wherein the intensity distribution of the laser beam is substantially uniform across the rectangular illumination field.

60. The method of claim 56, wherein the step of moving the optical diffuser further comprises:
vibrating the optical diffuser in a direction perpendicular to the propagation path of the laser beam.

61. The method of claim 56, wherein the step of moving the optical diffuser further comprises:
spinning the optical diffuser by spinning a wheel on which the optical diffuser is attached.

62. The method of claim 56, further comprising:
reducing a diameter of the laser beam by a beam reducing assembly.

63. The method of claim 56, wherein the spatial light modulator comprises an array of reflective and deflectable micromirrors.

64. The method of claim 63, wherein the rectangular illumination field has an aspect ratio of 16:9, 16:10, or 4:3.

65. The method of claim 63, wherein the rectangular illumination filed has a diagonal of substantially 0.7 inch or less.

66. The method of claim 63, wherein the rectangular illumination filed has a diagonal of substantially 0.5 inch or less.

67. The method of claim 63, wherein the rectangular illumination filed has a diagonal of substantially 0.3 inch or less.
